(19) United States
(12) Patent Application Publication
(10) Pub. No.: US 2012/0280570 A1
(43) Pub. Date: Nov. 8, 2012

(54) ELECTRICAL POWER DISTRIBUTION INSTALLATION

(76) Inventors: David Smythe, Alice Springs (AU); Grant Behrendorff, Alice Springs (AU)

(21) Appl. No.: 13/057,191

(22) PCT Filed: Aug. 6, 2009
(86) PCT No.: PCT/AU09/01005

§ 371 Date: May 3, 2011

(30) Foreign Application Priority Data
Aug. 6, 2008 (AU) 2008904019

(51) Int. Cl. H02J 3/00

(52) U.S. Cl. 307/69

(57) ABSTRACT

An electrical power transmission system where there are solar cells attached to a plurality of transmission poles. The cells are in panels wrapped around the poles to reduce windage loading and visual impact.

This invention relates to an electrical power distribution installation and in particular to provision of solar derived electrical energy in relation to such an installation.

### BACKGROUND OF THIS INVENTION

It is well known for electrical supply grids that there be provided spaced apart poles to which there are strung wires by which electrical power is transmitted to a distributed network.

It is also well known that in relation to any such distribution grid, that there are electrical losses caused simply by having any electrical power transmitted through wires, that the electrical power is reduced by reason of distance from a supply to the end user.

It is known to have solar cells located at an end use location where for instance a domestic home or even commercial installation may have a solar collector located on its roof and connected to its electrical supply by appropriate connectors.

It is known that such installations require specific supports and customised connections to a domestic or commercial premises and are therefore relatively expensive and depend on each individual owner committing to an investment related to their own circumstances.

There is no doubt that there would be advantage if the use of solar energy was able to be increased especially in connection with an electrical reticulated supply but there are specific difficulties which include, for an electrical supplier, that such a supplier needs to find one or more locations which, in order to minimise transmission losses, are relatively close to an expected users connection, and the cost relating to any such installation shall be able to be considered reasonable, and that any such installation or installations shall otherwise be able to be achieved where they might be relatively safe from interference or removal, and otherwise be acceptable in all of the circumstances.

### OBJECT OF THIS INVENTION

An object of this invention is to assist and facilitate economic additional supply of electrical power derivable from the sun.

### SUMMARY OF THE INVENTION

My discovery is that I can locate a solar panel on a plurality of power poles that are conventionally used to support power transmission wires.

I can locate a panel of solar cells so that they will be attached only to an upper part of the pole and positioned so that they wrap around the pole so as to reduce windage load and otherwise be oriented so that they will be on a preferred sun receiving side of the pole.

If such panels of solar cells are located in such a way on a plurality of poles, they firstly have the advantage of not being visually prominent and will therefore be expected to not raise the ire of the public from an appearance point of view. Secondly, by having a panel of cells which can be wrapped to extend partially around a pole, it can be expected that apart from minimising visual intrusion, this will also reduce the amount of wind such a panel would otherwise potentially collect and would therefore reduce the potential need for redesign of the strength of the pole and its attached wires.

Windage loading on wires and poles can be a significant engineering factor in the design of the poles and in order to maintain an economic basis for the proposal, the concept of wrapping the panel around the pole or at least partially around the pole so as to be positioned predominantly anyway in the most receptive solar receiving position, minimises potential for excessive vulnerability to wind.

In preference, a solar panel itself while being able to be wrapped around and be attached thereby to an upper part of a pole, can be positioned so as to be set off or leave between an outer surface of the pole and an inner side of the panel or at least an inner surface portion of the panel a channel or channels so as to facilitate conduction of air therethrough and thereby assist in effecting convection cooling of a panel.

In preference, the panel is positioned at an upper part of the pole which is to say it that it has a lower part which is substantially above a ground base in order to reduce easy access thereto from persons who may wish to interfere with the panel or otherwise act in an inappropriate way.

Further, an upper part of the panel conveniently have its upper end just below a cross bar on which insulators are attached and wires which are supported by the insulators.

As it is expected that such installations will be normally located on already installed poles, the orientation of each panel will be chosen appropriately so that for a given latitude on the earths surface, the alignment around the pole shall be chosen so that the panel will be appropriately aligned and that generally the width of the panel will be such that it will extend perhaps in a preferred instance around about half of a circumference of a pole.

One of the issues with a panel of solar cells is that they can be constant current devices. Accordingly a total current through series connected cells is governed by the amount of current that a least effective cell is allowing through. With a passive solar cell array that is comprised of cells facing in divergent directions, then there is a challenge as to how to achieve better current levels where some cells may not be receiving as much sun radiation as others.

This is especially an issue where a panel is intended to be wrapped around at least to some extent a pole so that only some of the cells at any one time will be facing directly into the sun.

We propose however to couple the cells in the array so that they are to be in vertically aligned groups this vertical orientation being when in position being wrapped at least to some extent around the pole. By then coupling the series coupled cells which in position would be sequentially around the pole, in parallel, allows for each group of vertically aligned cells to be in turn directly lighted by the suns rays and this then will deliver a relatively consistent substantial current for that specific series of cells when being directly lighted by the sun. Other adjacent vertical groups of cells will still be expected to contribute some current. Additionally, appropriately located diodes can ensure that the mainly contributing group of cells will not lose some of the current back through non performing cells.

It is implicit that any solar cell shall be connected through an appropriate electronic circuit so that its output can be coupled to a mains electrical supply which may typically be a 240 volt or 110 volt alternating current supply and such connectors can conventionally be an appropriate phase locked inverter.

In preference, it is considered that by having a plurality of such installations distributed through an installation grid, that this will provide electrical power in locations where the distance from conventional or intending user will be relatively short and therefore transmission losses will be also appropriately minimal.

In one form then the invention could be said to reside in an arrangement where there are a plurality of electric power supply poles supporting sequentially an electric power transmitting cable or cables and take offs for users from such cables, each of a plurality of the poles having a lower end embedded in the ground and being supported thereby to extend at least approximately vertically therefrom, the electric power transmitting cables being supported at or near a top of each respective pole, and a panel comprising or including solar receiving cells being solar to electric transducers distributed across said panel attached one to each of a plurality of the poles and for each panel there is an electronic circuit electrically connected to the cells and providing translating of electrical power from said cells to a phase and voltage matching input into the distribution network.

In a further form then the invention could be said to reside in an electrical power distribution installation with sequentially aligned power poles supporting electrical distribution wires and having connected thereto electrical feeds including a group of ground supported power poles positioned and spaced apart alignment each supporting on a cross arm or arms, electrical wires and extending from pole to pole to provide a common electrical grid providing an electrical power distribution network, and at least one of the poles having a panel of solar cells attached to and being supported by the pole and positioned to have an upper extent of active solar cells being below any cross arm and having any lowest portion substantially above a ground level, being secured to allow a surface of a respected pole and extending at least partially around the pole so that it is orientated in an appropriate better sun receiving position around the pole.

In a further form, the invention could be said to reside in an electrical power distribution installation including a plurality of ground support power poles positioned and spaced apart alignment each supporting on a cross arm or arms, electrical wires which also extend from pole to pole to provide a common electrical grid providing an electrical power distribution network using a first common electrical power source derived from a transformer provided by electrical power at a higher voltage, and at least one of the poles having a panel of solar cells attached to and being supported by the pole and positioned to have an upper extent of active solar cells being below any cross arm and having any lowest portion substantially above a ground level, to an outer surface thereto being positioned so as to only extend approximately coincidentally across a face or faces that is or are aligned to receive at least substantial sunlight directly.

In preference, the panel of solar electrical cells is in sheet form and shaped with a curve about a vertical axis with a pole portion aligned and positioned within a concave shape provided by such curve.

### BRIEF DESCRIPTION OF THE INVENTION

For a better understanding of this invention it will now be described with the assistance of drawings wherein

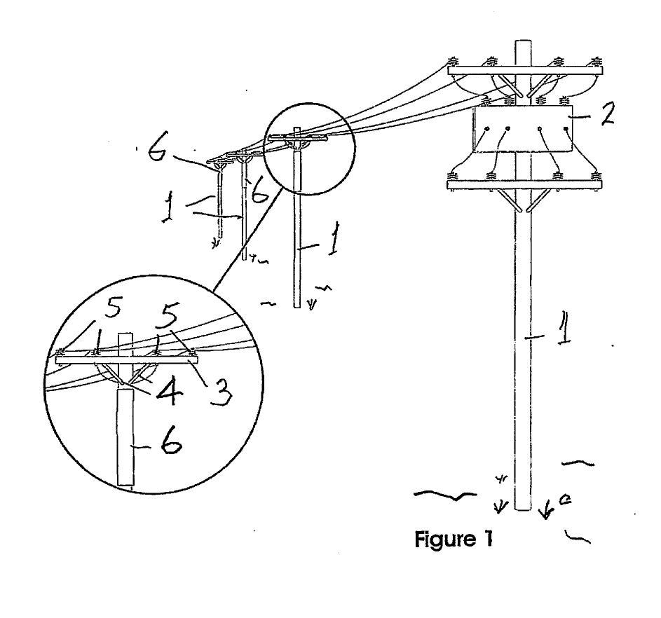

FIG. 1 is showing in schematic form a plurality of poles supporting a power distribution grid or at least a very small part of this and having a solar panel attached as described to an upper part of each of three of the poles shown,

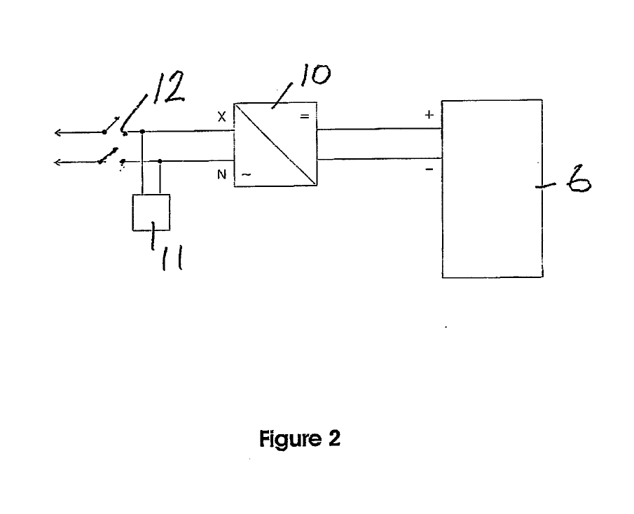

FIG. 2 illustrates an electrical circuit where the solar panel is connected to an inverter with phase locking which is connected to an appropriate phase of the power supply wires to which the pole is attached and there is provided here an over voltage device,

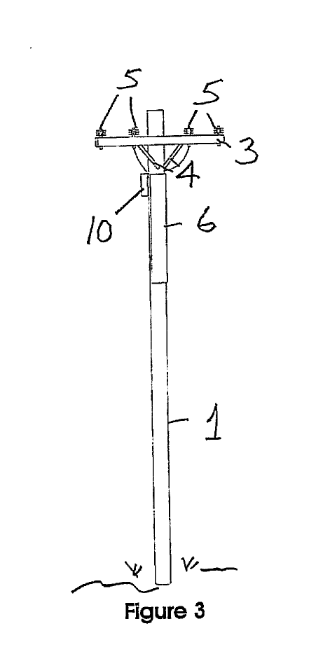

FIG. 3 shows in specific detail a pole having such a solar panel attached, and

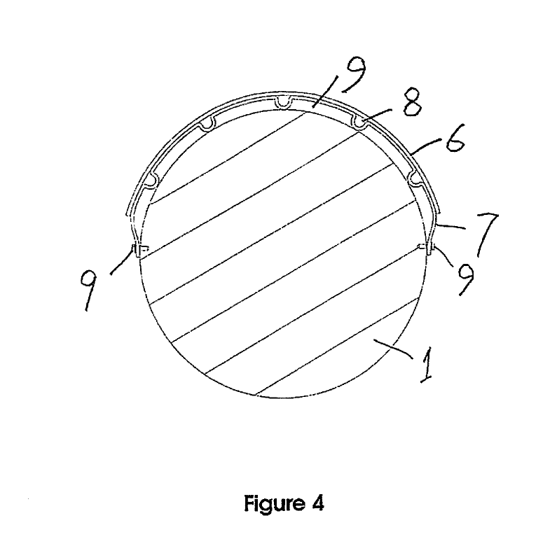

FIG. 4 is a cross sectional view through the pole as shown in FIG. 3 illustrating the way in which the solar cell panel is supported with its back surface allowing for open channels to assist in ventilation and convection cooling.

Referring in detail to the drawings, there are a plurality of poles 1 which in FIG. 1 at least a few of these are shown and there is a transformer 2 to which is connected to some higher voltage supply and this provides a low voltage alternating current output (240 volts RMS) which would normally be many poles and a wide distribution grid.

The poles 1 in each case include a cross bar 3 to and this in conventional manner is held by struts 4 and supports insulators 5.

In accordance with this invention, there is a solar panel 6 which is of a form which can be manipulated in shape so that it can wrap around a conventional circumference of a pole 1 and in this case is secured to a sub frame 7 which is specifically shown in FIG. 4 which provides a plurality of vertical channels 8 and 9 and which of itself consists of a material assisting heat dissipation from the solar cells 6.

This backing sheet is secured by screws 9.

The length of the solar panel 6 is such that, when compared to the total height of a pole 1, ensures that if an upper edge of the panel 6 is just below the cross bar, then its lower end will be substantially above a height that would normally be accessible by a person walking by such pole.

This might traditionally then be higher than two metres with the then further height of the panel being five metres.

The orientation of the panel will be chosen on a pole-by-pole basis so that the polar alignment of its cells will be chosen appropriately for the position of the pole and of course relative to the latitude so that the sun during the day will sequentially shine directly on groups in sequence of solar cells in the panel.

In this way each of the cells in a group can be and are connected in series so that being a constant current device they will be together illuminated to a similar extent by facing in a common direction toward the sun.

In other words the solar cells are connected in vertically aligned groups with the cells in each respective group being electrical connected in series, and the groups being connected together in parallel. Suitable diode protection may be positioned to avoid current loss to non illuminated groups.

In order for the solar cell groups to function they are held in a common matrix which may be similar to a flexible sheet so that by flexing around a pole, the respective groups of cells can be kept in a vertical alignment but adjacent groups will be aligned in a sequentially diverging polar direction.

Another way of describing this is that there is a collected plurality of solar cells on a common support material or materials which comprise groups of vertically aligned solar cells with the cells in each group being aligned to be directed in substantially a same polar direction, and a first group of solar cells is directed collectively in a first polar direction, a second group of solar cells being adjacent the said first group of solar cells is directed in a different polar direction from said first group, and a further group of solar cells being adjacent the said second group of cells is directed in a substantially further polar direction such that they are positioned to be externally facing and following at least approximately around some of a circumference of a supporting pole.

The electrical connection between the solar cells 6 and the grid is in this case achieved by an inverter with phase sensing 10 and an over voltage bypass 11 as well as an interrupter 12.

It is envisaged that the panel might be attached to only some of the poles and it is also envisaged that there could in some cases be more than one panel attached to a pole where perhaps the available area on the pole is such to accommodate such further panel. A challenge with solar cells being directly illuminated by the sun is that they can become hot and their efficiency is compromised. Accordingly we have arranged that any panel is positioned to allow for convention induced ventilation between the back of the panel and a pole.

The wrapping in this embodiment is 120 degrees polar angle between the direction pointed by a group on one side of the panel to the direction pointed to by the group of cells on an opposite side of the panel.

It is also envisaged that while a single panel of solar cells may be wrapped around a pole, there may be two or more such panels on the same pole which could include one of more groups of cells in a vertical alignment so that there may be separate vertical groups of solar cells. Or in an alternate embodiment there may be a plurality of panels one above the other and in this case with some elevation in direction to accord with the suns path.

As an indication of the spread of polar direction of the groups in a panel this could be within the range of from 90 degrees to 150 degrees.

While the poles are shown as generally cylindrical, and this might for instance apply therefore to wooden poles, it is not envisaged that such poles should be necessarily limited to such wooden poles and the wrapping around can be accommodated in relation to even poles having oblong shapes such as those known in other places and made for instance from reinforced concrete, or steel girders.

By providing such wrapping around a pole this reduces the visual impact and therefore also allows for a somewhat larger number of solar cells to be positioned on a pole without unduly creating an unsightly view. Also wind loading is much less of a difficulty. This compares with flat panels which will still suffer from alignment not being ideal for much of a day because they have a passive alignment, and offering a substantial face to the wind and potentially a constraint to their use.

1. An arrangement where there are a plurality of electric power supply poles supporting sequentially an electric power transmitting cable or cables and take offs for users from such cables, each of a plurality of the poles having a lower end embedded in the ground and being supported thereby to extend at least approximately vertically therefrom, the electric power transmitting cables being supported at or near a top of each respective pole, and a panel comprising or including solar cells being solar to electric transducers distributed across said panel, being attached one to each of a plurality of the poles and being at least to some extent in each case wrapping around its respective vertically aligned pole, and for each panel an electronic circuit electrically connected to the cells and providing translating of electrical power from said cells to a phase and voltage matching input into the said electrical distribution network.

2. An arrangement as in claim 1 where the electric power transmitting cables are supported by cross trees secured to each respective pole.

3. An arrangement as in claim 1 further characterized in that at least some of the solar cells are in the form of a panel which is at least to some extent wrapped around a supporting pole and orientated so that at least some of the solar cells will be directly illuminated by the sun during at least most of a day.

4. An arrangement as in claim 1 in which at least some of the solar cells are positioned to be in a vertically aligned group facing in a common polar direction and where the cells in the group are electrically connected in series.

5. An arrangement as in claim 4 where there are a plurality of such vertically aligned groups positioned adjacent one to the other and aligned to be for each group in a different pointing polar direction so that the sun will sequentially illuminate each of the groups predominantly through a day.

6. An arrangement as in claim 1 where the panel of solar cells is supported so as to have a cooling air space between the cells and the pole.

7. An arrangement as in claim 4 where the spread of polar direction of the groups in a panel are within the range of from 90 degrees to 150 degrees.

8. An arrangement as in claim 1 further characterised in that each solar panel is set off to leave between an outer surface of the pole and an inner side of the panel or at least an inner surface portion of the panel a channel or channels so as to facilitate conduction of air therethrough and thereby assist in effecting convection cooling of a panel.

9. An arrangement as in claim 1 further characterised in that each panel is positioned only at an upper part of the pole.

10. An arrangement as in claim 1 further characterised in that the solar cells are connected to either a 240 volt or 110 volt alternating current supply by a phase locked inverter.

11. An electrical power distribution installation with sequentially aligned power poles supporting electrical distribution wires and having connected thereto electrical feeds including a group of ground supported power poles positioned and spaced apart alignment each supporting on a cross arm or arms, electrical wires and extending from pole to pole to provide a common electrical grid providing an electrical power distribution network, and at least one of the poles having a panel of solar cells attached to and being supported by the pole and positioned to have an upper extent of active solar cells being below any cross arm and having any lowest portion substantially above a ground level, being secured to allow a surface of a respected pole and extending at least partially around the pole so that it is orientated in an appropriate better sun receiving position around the pole.

12. An electrical power distribution installation including a plurality of ground support power poles positioned and spaced apart alignment each supporting on a cross arm or arms, electrical wires which also extend from pole to pole to provide a common electrical grid providing an electrical power distribution network using a first common electrical power source derived from a transformer provided by electrical power at a higher voltage, and at least one of the poles having a panel of solar cells attached to and being supported by the pole and positioned to have an upper extent of active solar cells being below any cross arm and having any lowest portion substantially above a ground level, to an outer surface thereto being positioned so as to only extend approximately coincidentally across a face or faces that is or are aligned to receive at least substantial sunlight directly.

13. An electrical power distribution installation as in claim 11 further characterised in that the panel of solar electrical cells is in sheet form and shaped with a curve about a vertical axis with a pole portion aligned and positioned within a concave shape provided by such curve.

14. An electrical power distribution installation as in claim 12 further characterised in that the panel of solar electrical cells is in sheet form and shaped with a curve about a vertical axis with a pole portion aligned and positioned within a concave shape provided by such curve.
